(19) United States
(12) Patent Application Publication
(10) Pub. No.: US 2008/0183813 A1
(43) Pub. Date: Jul. 31, 2008

(54) Mechanism for entering, storing, pairing and providing user-defined and contact-defined contact information

(75) Inventor: Horace James Caulkins, Chappaqua, NY (US)

Correspondence Address: HJCV, LLC, 24 CREST ROAD, CHAPPAQUA, NY, 10514, US

(73) Assignee: HJCV LLC, Chappaqua, NY (US)

(21) Appl. No.: 11/627,928

(22) Filed: Jan. 26, 2007

(51) Int. Cl. G06F 15/16

(52) U.S. Cl. 709/204

(57) ABSTRACT

The mechanism pertains to a databases generally located on a remote server and accessed via such vehicles as the World Wide Web. The mechanism revolves around a grouping of contacts for a user. The user defines contact and other information for each contact (user-defined information). Simultaneously, contacts provide information on themselves which is also posted to the interface (contact-defined information). The mechanism synthesizes and pairs these two sets of information and serves it to the user.

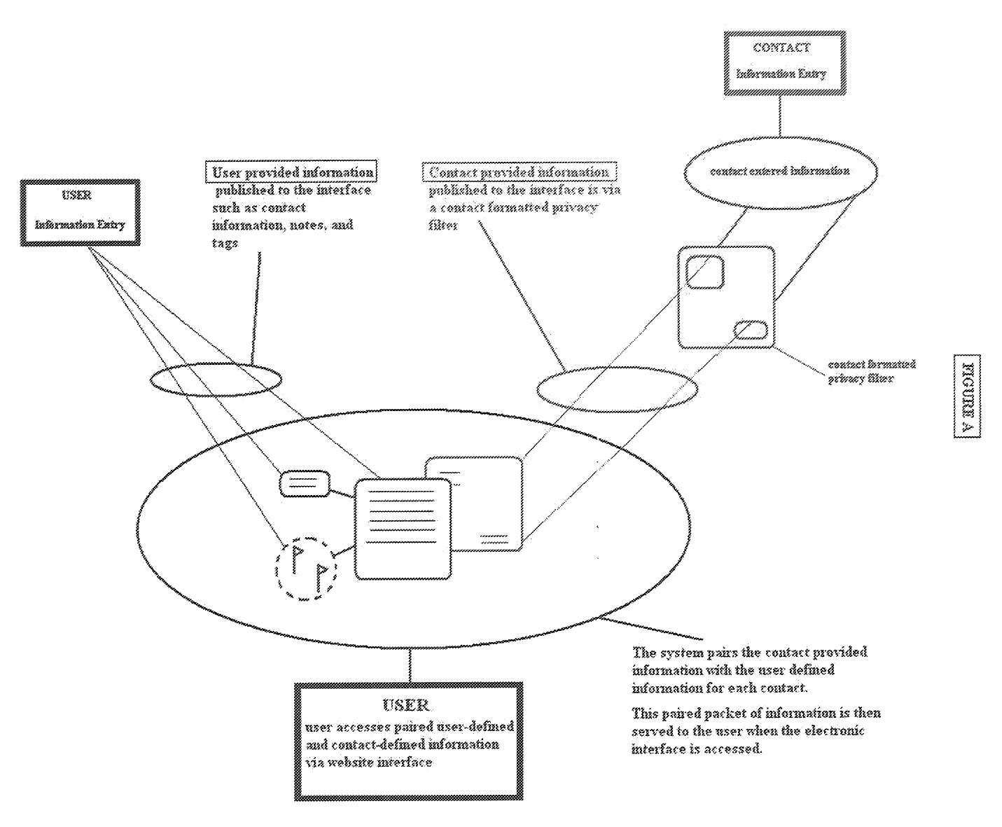

### TECHNICAL FIELD AND APPLICABILITY OF THE INVENTION

The invention applies generally to methods, systems and mechanisms for managing personal and professional contact information. More specifically, the invention applies to mechanisms by which contact information is compiled, where it comes from, and how it is packaged, accessed and presented. The invention works mainly in conjunction with personal computers on a remote server, generally accessed by a vehicle such as the World Wide Web.

### BACKGROUND OF THE INVENTION

Management and maintenance of personal and professional contact information has always been a paramount concern for many individuals. This need has been targeted by numerous utilities. There is a plethora of contact management tools currently available, including: address books, personal information managers, contact relationship managers, organizers and others. These utilities store information such as name, phone numbers, electronic mail addresses, physical mail addresses, and even notes.

Recently, internet services have provided storage, maintenance and displaying mechanisms which target the need for contact management as well, via the World Wide Web. These systems allow a user to enter their information on other contacts via manual entry, or through automation. Automated mechanisms include synchronization with other contact management instruments extraneous to the remote server, such as a PDA or desktop organizer, or through electronic mail.

In the past, the majority of previous mechanisms, both internet-based and otherwise, the direct source of information entry and editing is the utility user. In the example of a PC-based desktop organizer, often the information is entered and then edited by hand by the user, or by electronic mail received by the user and subsequently posted to the utility. In similar facilities for contact information storage and management accessed via the internet, contact information is entered specifically by the user when the user accesses the interface; this can be via synchronization with a PDA or desktop organizer, or via other mechanisms. The reliance only on user-based information entry, in any and all of its forms, presents cumbersome issues, such as slow updating time, editing errors, large time requirements of the user, et cetera.

To shift this burden and hindrance, there have been a few cases of mechanisms which have shifted the information entry burden to the contacts. An example of this is an electronic mail based mechanism which sends automated requests to contacts, asking them to confirm or change their information. All of these mechanisms rely on the contact entering, confirming or assigning information in order to make the updating process more convenient for the utility user.

Both of these scenarios (user entry and the later developed contact entry) present problems. For user-reliant entry, the system relies solely on the entry of information by the user, and therefore keeping an accurate, relevant and up to date “address book” is difficult and time consuming. Conversely, the contact-reliant entry mechanism requires that contacts spend time on entering information, and receive no “reward,” rendering this type of system minimally effective.

It would be therefore desirable to significantly expand upon this, and create a contact information management mechanism which synthesizes the utilization of both the user and the contact as sources of information.

### PRIOR ART

User-Reliant Mechanisms—In the vast majority of previous mechanisms, both internet-based and otherwise, the direct source of information entry and editing is the utility user.

In the example of a PC based desktop organizer, the information is often entered and then edited by hand by the user, or by electronic mail received by the user and subsequently posted to the utility. Commercially available personal information managers include “Maximizer” from Maximizer Technologies, “Act” from Symantec Corporation, “Janna Contact” from Janna Systems Inc. of Toronto, Ontario, Canada, “Schedule+” from Microsoft Corporation of Redmond, Wash., USA, and “Lotus Organizer” from IBM Corp. of Armonk, N.Y., USA. Personal information managers may also be a part of larger application programs, such as, for example, the Netscape web browser from Netscape Communications Corp. of Mountain View, Calif., USA and Lotus Notes from IBM Corp. The personal information manager capability in the Netscape web browser is referred to as “Address Book” and in the Lotus Notes program is referred to as “C&S” or “Calendar and Scheduler.” Each of these utilities directly relies on information entry either automatically or manually by the user, the user's PC or via some other related mechanism.

In similar facilities for contact information storage and management accessed via the internet, contact information is entered specifically by the user when the user accesses the interface; this can be via synchronization with a PDA or desktop organizer, or via other mechanisms. A number of web portals (e.g., Yahoo of Santa Clara, Calif., and Excite Inc. of Redwood City, Calif.) have incorporated address book and calendaring features into the services provided by these portals. In addition, many other mechanisms have been developed to attempt to satisfy the need for managing contact information, such as the electronic mail based mechanism developed by Morkel (U.S. Pat. No. 7,007,068) and the communications based mechanism developed by Creswell, et al. (U.S. Pat. No. 6,564,264). The reliance only on user-based information entry, in any and all of its forms, presents drawbacks as previously outlined.

Contact-Reliant Mechanisms—To shift the burden of information entry, there have been a few cases of mechanisms which have shifted the hindrance to the contacts. An example of this is Plaxo, Inc. (of Mountain View, Calif. USA—U.S. Pat. No. 7,080,104) which developed an electronic mail based mechanism which sends automated requests to contacts, requiring them to confirm or change their information. The other two somewhat related mechanisms are those developed by Celik (U.S. Pat. No. 6,654,768) and Schroeder, et al. (U.S. Pat. No. 6,760,727). However, both of these machinations also rely on the contact entering, confirming or assigning information in order to make the updating process more convenient for the utility user. These utilities lose functionality as contacts become tired of receiving constant requests for confirmation, updating and entry of the same information and see little reward for their time.

Our Invention—Our invention provides a mechanism which synthesizes both user-entered and contact-entered information. The mechanism then pairs this information and the user is able to access it via electronic interface, such as via access to the World Wide Web. The new mechanism combines the benefits of the two previous categories of contact management information sources (user and contact) and also avoids many of the negative aspects of these forms.

### SUMMARY OF THE INVENTION

The invention operates mainly on a remote server which is accessed by the World Wide Web. A user of the mechanism has an allotted amount of space on the server for storage of their information. On this space a user has an “address book” utility.

The utility revolves around contact names or e-mail addresses that a user denotes. The user can then enter information on these contacts (“user-defined information”), such as e-mail addresses, telephone numbers, fax numbers, addresses, employers and even notes. This information is then stored on the remote server, and is accessible by the user from anywhere with internet access.

The mechanism also includes contact entered information. The contacts of the user will also have access to the mechanism via the World Wide Web. Via this access, they will be able to enter information about themselves (at one location) which will be served to the user (as well as other users). When the contact edits or updates hi/her information, the user receives this information the next time he/she accesses the remote server mechanism. Likewise, the user can edit or change his/her user-entered information at any time.

Contacts are incentivised to enter information about themselves because they will also have an allotted space on the remote server. They will also have an “address book” and will need to enter their own information only once. This is an improvement over the previous solely contact-reliant information entry as the contact does not need to confirm, respond to, or enter their information multiple times. This is an improvement over the solely user-reliant information entry because the via the pairing the user can have up-to-date information without the need to constantly enter, edit or synchronize information.

Further, the mechanism then synthesizes the contact-entered and user-entered information into on interface (Figure A). This interface is displayed to the user via the World Wide Web when the user accesses the mechanism.

We claim the following:

1. A mechanism associated with a remote server accessed via vehicles such as the World Wide Web. The mechanism revolves around a grouping of contacts for a user. The user defines contact and other information for each contact (user-defined information). Simultaneously, contacts provide information on themselves which is also posted to the interface (contact-defined information). The mechanism pairs these two sets of information and serves it to the user.

2. The mechanism claimed in 1, wherein the user-defined information is entered for each contact by the user and posted to the server.

3. The mechanism claimed in 2, wherein the user-defined information consists of contact information, notes and other information.

4. The mechanism claimed in 1, wherein the contact-defined information is provided by contacts of the individual who access the interface and post information about themselves, such as contact information.

5. The mechanism claimed in 4, wherein contact-defined information is filtered through a privacy filter created by the contact.

6. The mechanism claimed in 1, wherein the user-defined and contact-defined information is paired via an electronic interface and stored on a remote server.

7. The mechanism claimed in 5 wherein the paired information is accessed via an electronic mechanism (e.g. website) and a vehicle (e.g. World Wide Web).

8. The mechanism claimed in 1, wherein the user-defined and contact-defined information can be modified by the user or contact (respectively) at any time by accessing the remote server.
